(19) United States
(12) Patent Application Publication
(10) Pub. No.: US 2003/0235482 A1
(43) Pub. Date: Dec. 25, 2003

(54) Screw

(76) Inventor: Teng-Hung Lin, Kaohsiung Hsien (TW)

Correspondence Address: Keith Kline, PRO-TECHTOR INTERNATIONAL SERVICES, 20775 Norada Court, Saratoga, CA, 95070-3018, US

(21) Appl. No.: 10/175,609

(22) Filed: Jun. 19, 2002

(51) Int. Cl. F16B 25/10

(52) U.S. Cl. 411/387.1

(57) ABSTRACT

Screw having quick drilling speed and smoothened expulsion of chips. The normal thread formed on the stem of the screw directly extends through the conic section of the tail end of the screw to the tip thereof by a larger guide angle. The thread between the changing point of the guide angle of the thread and the tip of the conic section serves as a thread with cutting/drilling and chip-expelling function. Therefore, the cutting/drilling and chip-expelling thread of the screw is directly formed by means of changing the guide angle of the normal thread of the screw.

### BACKGROUND OF THE INVENTION

The present invention is related to an improved screw.

The structure of a screw is varied with the material of a work piece in which the screw is to be screwed. However, it is always required that the screw be quickly, easily and firmly screwed into the work piece. When the screw is screwed to drill the work piece, the smoothness of expulsion of the chips will directly affect the screwing speed and the value of applied torque. In the case that the thread of the screw is such designed as to smoothly expel the chips, the screw can be easily and quickly screwed into the work piece with less torque. Reversely, the resistance will be greater and the screwing speed will be slower and the needed torque will be greater. Therefore, it is necessary to provide a screw structure having better drilling and chip-expelling effect.

In various conventional designs, another cutting/drilling blade or thread is formed between the normal thread of the screw or on a certain section of the screw. That is, the drilling thread and the normal thread are independently formed on the same screw. Accordingly, multiple intersecting angles are contained between the drilling thread (blade) and the normal thread. Such intersecting angles act as resistance points against the expulsion or the chips when drilling the work piece. Therefore, the expulsion of the chips is obstructed and the drilling speed is slowed and the needed screwing torque is increased.

### SUMMARY OF THE INVENTION

It is therefore a primary object of the present invention to provide an improved screw in which the cutting/drilling and chip-expelling thread is directly formed of the thread of the screw. Therefore, it is unnecessary to additionally design drilling thread (blade). Also, the resistance against the drilling and expulsion of chips caused by the intersecting angles is avoided.

It is a further object of the present invention to provide the above improved screw in which the drilling operation is speeded and the screwing torque is lowered.

The present invention can be best understood through the following description and accompanying drawings wherein:

### BRIEF DESCRIPTION OF THE DRAWINGS

FIG. 1 is a top view of the screw of the present invention; and

FIG. 2 is a bottom view of the screw of the present invention.

### DETAILED DESCRIPTION OF THE PREFERRED EMBODIMENT

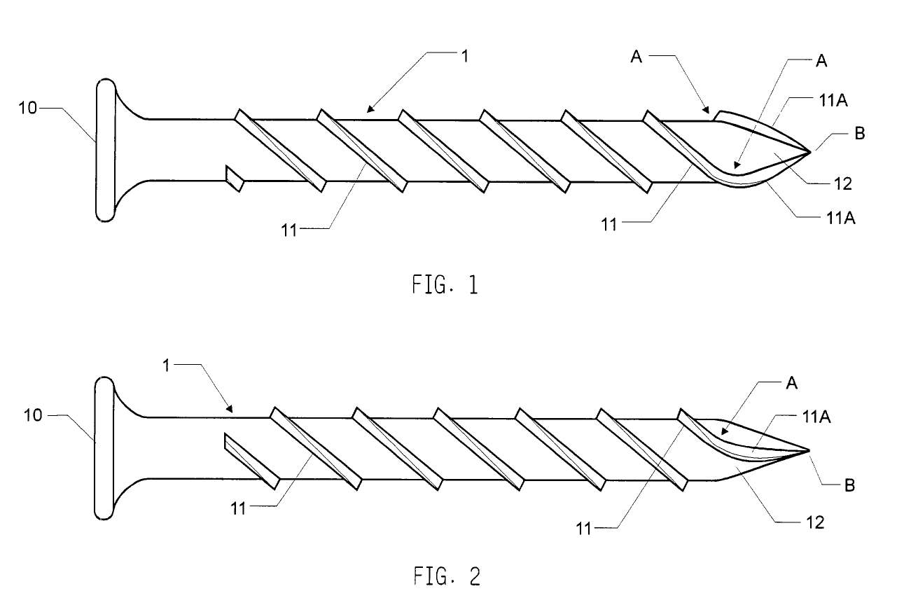

Please refer to FIGS. 1 and 2. The screw 1 of the present invention includes a screw head 10, a thread 11 and a conic section 12 at the tail end of the screw 1. The present invention is characterized in that the thread 11 of the screw 1 spirally extends through the conic section 12 of the screw 1 or to the tip B of the conic section 12 by another guide angle. The thread between the changing point A of the guide angle of the thread 11 and the tip B of the conic section 12 serves as a thread 11A with cutting/drilling and chip-expelling function. That is, the cutting/drilling and chip-expelling thread 11A of the screw 1 is directly formed by means of changing the guide angle of the thread 11 of the screw 1.

The present invention has the following advantages:

1. The cutting/drilling and chip-expelling thread 11A is directly formed of the screw's own thread. Therefore, the drilling and expulsion of the chip are smoothened. The problem caused by the intersecting angles contained by different threads of the conventional screw is avoided.

2. The remaining chips produced by the cutting thread 11A are directly upward guided into the successive thread 11 so that the drilling operation is speeded and the resistance is less.

3. The screw of the present invention has simple structure and better utility.

The above embodiment is only used to illustrate the present invention, not intended to limit the scope thereof. Many modifications of the above embodiment can be made without departing from the spirit of the present invention.

What is claimed is:

1. Screw having a thread, the thread spirally extending through a conic section of the tail end of the screw by another guide angle, whereby the thread between the changing point of the guide angle of the thread and the tip of the conic section serves as a thread with cutting/drilling and chip-expelling function, the cutting/drilling and chip-expelling thread of the screw being directly formed by means of changing the guide angle of the thread of the screw.

2. Screw as claimed in claim 1, wherein the thread of the screw spirally extends through the conic section of the screw to the tip thereof by another guide angle.
